(19) United States
(12) Patent Application Publication
(10) Pub. No.: US 2024/0105910 A1
(43) Pub. Date: Mar. 28, 2024

(54) NEGATIVE ELECTRODE ACTIVE MATERIAL LAYER AND SOLID-STATE BATTERY

(71) Applicant: TOYOTA JIDOSHA KABUSHIKI KAISHA, Toyota-shi Aichi-ken (JP)

(72) Inventors: Azusa Nakanishi, Susono-shi Shizuoka-ken (JP); Shinji Nakanishi, Mishima-shi Shizuoka-ken (JP)

(73) Assignee: TOYOTA JIDOSHA KABUSHIKI KAISHA, Toyota-shi Aichi-ken (JP)

(21) Appl. No.: 18/372,284

(22) Filed: Sep. 25, 2023

(30) Foreign Application Priority Data
Sep. 26, 2022 (JP) 2022-152734

(51) Int. Cl. H01M 4/134; H01M 4/04; H01M 4/133; H01M 4/1393; H01M 4/1395; H01M 4/38; H01M 4/587; H01M 4/62; H01M 10/0525; H01M 10/0562

(52) U.S. Cl. CPC H01M 4/134; H01M 4/0435; H01M 4/133; H01M 4/1393; H01M 4/1395; H01M 4/386; H01M 4/587; H01M 4/62; H01M 10/0525; H01M 10/0562; H01M 2004/027; H01M 2300/0065

(57) ABSTRACT

A negative electrode active material layer and a solid-state battery, which can exhibit the inherent performance of porous silicon particles, are provided. The negative electrode active material layer of the present disclosure contains porous silicon particles, graphite particles, and inorganic solid electrolyte particles, and the ratio of the mass of the graphite particles to the total mass of the porous silicon particles and the graphite particles is 10 mass % to 25 mass %. In addition, the solid-state battery of the present disclosure comprises the negative electrode active material layer of the present disclosure, the solid electrolyte layers, and the positive electrode active material layer in this order.

### CROSS-REFERENCE TO RELATED APPLICATION

This application claims priority to Japanese Patent Application No. 2022-152734 filed on Sep. 26, 2022, the entire contents of which are herein incorporated by reference.

### FIELD

The present disclosure relates to a negative electrode active material layer and a solid-state battery including the negative electrode active material layer.

### BACKGROUND

The solid-state battery is a battery having a solid electrolyte layer between a positive electrode layer and a negative electrode layer, and has an advantage that simplification of the safety device is easy to achieve. Among solid-state batteries, solid-state lithium-ion batteries have attracted attention, because they can provide a high energy density by utilizing a battery reaction involving movement of lithium ions.

As the negative electrode active material used in the negative electrode layers of batteries, an active material containing silicon (Si) (silicon-containing active material) is known. The silicon-containing active material has an advantage that the theoretical capacity per volume is large, but on the other hand, there is a problem that the volume change due to charging and discharging is large, and the characteristics are easily deteriorated when the active material is repeatedly used.

In response to such a problem, as disclosed in Patent Literature 1, it is known to use porous silicon particles to suppress the effect of the volume change of silicon caused by charging and discharging.

[Patent Document 1] JP 2021-097017 JP

### SUMMARY

### Problem to be Solved

According to the use of porous silicon particles as disclosed in Patent Document 1, it is possible to suppress the effect of the volume change of silicon caused by charging and discharging.

However, the inventors of the present disclosure have found the following points:
For forming a negative electrode active material layer of a solid-state battery, it is necessary to press a negative electrode active material layer at a large pressure in order to improve contact between particles, and in particular, when sulfide solid electrolyte particles are used, it is necessary to press a negative electrode active material layer at a large pressure in order to deform sulfide solid electrolyte particles by pressing so as to improve contact between particles.
Pressing at such high pressures may at least partially destroy the porous structure of the porous silicon particles, thereby not providing the inherent performance of the porous silicon particles.

### Technique for Solving the Problem

The present inventors have found that the above problem can be solved by the following techniques, and have completed the present disclosure. That is, the present disclosure is as follows.

### [Aspect 1]

A negative electrode active material layer, wherein the negative electrode active material layer contains porous silicon particles, graphite particles, and inorganic solid electrolyte particles, and wherein the ratio of the mass of the graphite particles to the total mass of the porous silicon particles and the graphite particles is 10% by mass to 25% by mass.

### [Aspect 2]

The negative electrode active material layer according to Aspect 1, wherein the porous silicon particles are porous clathrate silicon particles.

### [Aspect 3]

The negative electrode active material layer according to Aspect 1, wherein the inorganic solid electrolyte particles are sulfide solid electrolyte particles, wherein the ratio of the total mass of said porous silicon particles and said graphite particles to the total mass of said porous silicon particles, said graphite particles, and said inorganic solid electrolyte particles is 30 mass %-85 mass %, and The average aspect ratio of the graphite particles is 1.5 or more, and D50 diameter of the graphite particles is 2 times to 20 times D50 diameter of the porous silicon particles,

### [Aspect 4]

A solid-state battery, comprising the negative electrode active material layer according to Aspect 1, the solid electrolyte layer, and the positive electrode active material layer in this order.

### [Aspect 5]

The method for producing a negative electrode active material layer according to Aspect 1, comprising roll pressing.

### Effect

According to the negative electrode active material layer of the present disclosure, it is possible to satisfactorily provide the effect of the porous silicon particles, that is, the effect of suppressing the influence of the volume change of the silicon due to charging and discharging, even in a solid-state battery.

### BRIEF DESCRIPTION OF THE DRAWINGS

FIG. 1 is a cross-sectional view illustrating an example of a solid-state battery.

FIG. 2 is a graph showing the relationship between the ratio of the mass of graphite particles to the total mass of porous silicon particles and graphite particles, and the porosity for the solid-state batteries of Examples and Comparative Examples.

FIG. 3 is a graph showing the relationship between the ratio of the mass of graphite particles to the total mass of porous silicon particles and graphite particles, and the capacity retention ratio of the solid-state batteries of Examples and Comparative Examples.

### DESCRIPTION EMBODIMENTS

Hereinafter, embodiments of the present disclosure will be described in detail with reference to the drawings. However, the embodiments shown in the drawings are examples of the present disclosure, and do not limit the present disclosure.

### Negative Electrode Active Material Layer

The negative electrode active material layer of the present disclosure contains porous silicon particles, graphite particles, and inorganic solid electrolyte particles, and the ratio of the mass of the graphite particles to the total mass of the porous silicon particles and the graphite particles is 10 mass % to 25 mass %.

According to the negative electrode active material layer of the present disclosure, even when the porous silicon particles are used and the inorganic solid electrolyte particles are used, the original performance of the porous silicon particles can be exhibited. Without being limited to any theory, it is believed that this is due to the fact that graphite particles, i.e., relatively hard particles having a relatively large aspect ratio, are contained in an appropriate proportion, so that the graphite particles function as a pillar structure, thereby suppressing the application of excessive pressure to the porous silicon particles during pressing and/or restraint necessary when using the inorganic solid electrolyte particles, i.e., suppressing the destruction of the porous structure of the porous silicon particles.

The negative active material layer may be more than or equal to 1 micrometer, more than or equal to 10 micrometers, more than or equal to 30 micrometers, or more than or equal to 50 micrometers, and may be less than or equal to 100 micrometers.

The negative electrode active material layer of the present disclosure can be produced by any method, and can be produced, for example, by coating a negative electrode mixture slurry containing porous silicon particles, graphite particles, and inorganic solid electrolyte particles on a substrate, and then drying and pressing the slurry.

In some embodiments, as the press in this case, a roll press is used in order to provide a large press pressure to the negative electrode active material layer. Here, the pressure of the roll press may be greater than or equal to 10 kN/cm, greater than or equal to 50 kN/cm, greater than or equal to 80 kN/cm, or greater than or equal to 100 kN/cm, and may be less than or equal to 500 kN/cm, less than or equal to 300 kN/cm, less than or equal to 200 kN/cm, or less than or equal to 100 kN/cm.

### (Porous Silicon Particles)

In the context of the present disclosure, porous silicon particles (porous silicon particles) are used as negative electrode active material particles. The porous silicon particles are silicon particles having pores inside the primary particles, and the pores can suppress expansion and contraction of the negative electrode active material particles during charging and discharging.

In this regard, for example, the porous silicon particles may have pores having pore diameters of 100 nm or less of 0.01 cc/g or more, 0.05 cc/g or more, or 0.10 cc/g or more, and may have the pores having pore diameters of 100 nm or less of 0.50 cc/g or less, 0.40 cc/g or less, 0.30 cc/g or less, 0.20 cc/g or less, 0.15 cc/g or less. The quantity of pores having pore diameter of less than or equal to 100 nm is the cumulative pore volume of the pores having pore diameter of less than or equal to 100 nm. The cumulative pore volume can be determined, for example, by mercury porosimetry or the like.

Porous silicon particles can be produced by any method. In particular, the porous silicon particles can be produced by known methods. For example, porous silicon particles can be produced by forming particles of an alloy of silicon and other metals, such as magnesium, lithium, and the like, and solving and removing other metals from the alloy particles.

The size of the porous silicon particles is not particularly limited. The median diameter (D50 particle diameter) of the porous silicon particles may be, for example, 0.1 μm or more, 0.3 μm or more, or 0.5 μm or more, and may be 50.0 μm or less, 30.0 μm or less, 10.0 μm or less, 5.0 μm or less, 3.0 μm or less, or 1.0 μm or less. The median diameter of the porous silicon particles is the particle diameter at which the cumulative value becomes 50% in the volume-based particle size distribution determined by the laser diffraction/scattering method (D50 diameter).

The porous silicon particles can also have a clathrate structure.

In some embodiments, the porous silicon particles have a clathrate structure in that expansion and contraction of the porous silicon particles due to charging and discharging of the battery are further reduced. Whether or not the porous silicon particles have a clathrate structure can be easily determined from Raman spectra, XRD, and the like. The porous silicon particles may have an oxide film or may contain impurities such as carbon.

### (Graphite Particles)

In the context of the present disclosure, graphite particles are used as negative electrode active material particles. The graphite particles are layered compounds composed of a large number of graphene layers, and are particles in which metal ions such as lithium ions can be inserted and desorbed between the graphene layers.

The size of the graphite particles is not particularly limited. The median diameter (D50 particle diameter) of the graphite particles may be, for example, 1.0 μm or more, 3.0 μm or more, or 5.0 μm or more, and may be 50 μm or less, 30 μm or less, 20 μm or less, 15 μm or less, or 10 μm or less. The median diameter of the graphite particles is the particle diameter at which a cumulative value becomes 50% in the volume-based particle size distribution determined by the laser diffraction/scattering method (D50 diameter).

The median size of the graphite grains may be larger than the median size of the porous silicon grains, for example, the median size of the graphite grains may be more than 2 times, more than 3 times, more than 4 times, or more than 5 times of that of the porous silicon grains, and also may be less than 20 times, less than 10 times, less than 15 times, or less than 10 times of that of the porous silicon grains.

Graphite particles usually have a relatively large aspect ratio. Here, the aspect ratio of the graphite particles is the ratio of the major axis length to the minor axis length (major axis length/minor axis length). The major axis length and minor axis length can be measured by imaging analysis, such as, for example, a microscope, a scanning-electron-microscope (SEM), etc. The average aspect ratio of the graphite particles is a number average value of aspect ratios measured by image analysis for graphite particles having a major axis length of not less than the median diameter, and may be not less than 1.5, not less than 2.0, or not less than 2.5, and may be not more than 10.0, not more than 9.0, not more than 8.0, not more than 7.0, not more than 6.0, not more than 5.0, not more than 4.0, or not more than 3.5.

The ratio of the mass of the graphite particles to the total mass of the porous silicon particles and the graphite particles may be 10% by mass or more, 11% by mass or more, 12% by mass or more, 13% by mass or more, 14% by mass or more, or 15% by mass or more, and may be 25% by mass or less, 24% by mass or less, 23% by mass or less, 22% by mass or less, 21% by mass or less, or 20% by mass or less.

### (Inorganic Solid Electrolyte Particles)

As the inorganic solid electrolyte particles, anything can be used.

Examples of the inorganic solid electrolyte particles include oxide solid electrolyte particles such as lithium lanthanum zirconate, LiPON, Li1+XAlXGe2−X(PO4)3, Li—SiO glasses, and Li—Al—S—O glasses; and sulfide solid electrolyte particles such as Li2S—P2S5, Li2S—SiS2, LiI—Li2S—SiS2, LiI—Si2S—P2S5, Li2S—P2S5-LiI—LiBr, LiI—Li2S—P2S5, LiI—Li2S—P2O5, LiI—Li3PO4-P2S5, Li2S—P2S5-GeS2. In particular, sulfide solid electrolyte particles, among them, sulfide solid electrolyte particles containing at least Li, S, and P as constituent elements are used, in some embodiments, because of their high performance The inorganic solid electrolyte particles may be amorphous or crystalline. Only one type of the inorganic solid electrolyte particles may be used alone, or two or more types may be used in combination.

In the negative electrode active material layer, the ratio of the total mass of the porous silicon particles and the graphite particles to the total mass of the porous silicon particles, the graphite particles, and the inorganic solid electrolyte particles (that is, the ratio of the mass of the negative electrode active material to the total mass of the negative electrode active material and the inorganic solid electrolyte particles) may be 30% by mass or more, 40% by mass or more, or 50% by mass or more, and may be 85% by mass or less, 80% by mass or less, 75% by mass or less, 70% by mass or less, 65% by mass or less, or 60% by mass or less.

The thickness of the negative electrode active material layer may be 1 μm or more, 10 μm or more, 15 μm or more, 20 μm or more, 30 μm or more, or 50 μm or more, and may be 100 μm or less, 80 μm or less, 60 μm or less, 40 μm or less, or 30 μm or less.

### (Other)

The negative electrode active material layer may include an electrolyte solution, a conductive aid, and/or an organic binder, in addition to the porous silicon particles, the graphite particles, and the inorganic solid electrolyte particles.

The electrolytic solution may include, for example, lithium ions as carrier ions. The electrolytic solution may be, for example, a nonaqueous electrolytic solution. For example, as the electrolytic solution, a solution obtained by dissolving a lithium salt in a carbonate-based solvent at a predetermined concentration can be used. Examples of the carbonate-based solvents include fluoroethylene carbonate (FEC), ethylene carbonate (EC), and dimethyl carbonate (DMC). Examples of the lithium salt include hexafluoride phosphoric acid. However, in some embodiments, the negative electrode active material layer does not contain an electrolyte solution in order to provide performance of the inorganic solid electrolyte particles.

Examples of the conductive aid include carbon materials such as gas phase carbon fibers (VGCF), acetylene black (AB), Ketjen black (KB), carbon nanotubes (CNT), and carbon nanofibers (CNF); and metallic materials such as nickel, aluminum, and stainless steel. The conductive aid may be, for example, particulate or fibrous, and the size thereof is not particularly limited. Only one kind of the conductive aid may be used alone, or two or more kinds may be used in combination.

Examples of the organic binder include a butadiene rubber (BR)-based binder, a butylene rubber (IIR)-based binder, an acrylate butadiene rubber (ABR)-based binder, a styrene butadiene rubber (SBR)-based binder, a polyvinylidene fluoride (PVdF)-based binder, a polytetrafluoroethylene (PTFE)-based binder, a polyimide (PI)-based binder, and a polyacrylic acid-based binder. Only one organic binder may be used alone, or two or more organic binders may be used in combination.

### Solid-State Battery

The solid-state battery of the present disclosure includes a negative electrode active material layer of the present disclosure, a solid electrolyte layer, and a positive electrode active material layer in this order. In particular, the solid-state battery of the present disclosure includes a negative electrode current collector layer, a negative electrode active material layer of the present disclosure, a solid electrolyte layer, a positive electrode active material layer, and a positive electrode current collector layer in this order.

In the present disclosure, solid-state batteries may include solid-state lithium-ion batteries, solid-state sodium-ion batteries, solid-state magnesium-ion batteries, and solid-state calcium-ion batteries. Among them, a solid lithium ion battery and a solid sodium ion battery are used in some embodiments. The solid-state battery of some embodiments of the present disclosure is a solid-state battery using sulfide solid electrolyte particles as solid electrolyte particles, that is, a sulfide solid-state battery.

The sulfide solid-state battery of the present disclosure may be a primary battery or a secondary battery, but, in some embodiments, is a secondary battery. This is because the secondary battery can be repeatedly charged and discharged, and is useful, for example, as an in-vehicle battery. Therefore, in some embodiments, the sulfide solid-state battery of the present disclosure is a solid lithium ion secondary battery.

In the present disclosure, the battery stack may be a monopolar battery stack or a bipolar battery stack.

The battery stack of the solid-state battery of the present disclosure may be constrained in the stacking direction in use. According to this configuration, it is possible to further promote the battery reaction by improving the conductivity of ions and electrons inside each layer and between each layer of the battery stack during charging and discharging.

The constraining force is not particularly limited, and may be, for example, 1.0 MPa or more, 1.5 MPa or more, 2.0 MPa or more, or 2.5 MPa or more. The upper limit of constraining force is not particularly limited, for example, below 50 MPa, below 30 MPa, below 10 MPa, or below 5 MPa.

### (Positive Electrode Current Collector Layer)

The positive electrode current collector layer used in the solid-state battery of the present disclosure may be any common positive electrode current collector layer of a secondary battery. Positive current collector layer may be foil-like, sheet-like, mesh-like, panting metal-like, porous-like, and foam-like. The positive electrode current collector layer may be a metal foil or a metal mesh. In particular, the metal foil is useful in view of handling properties and the like. The positive electrode current collector layer may be formed of a plurality of metal foils. Examples of the positive electrode current collector include Cu, Ni, Cr, Au, Pt, Ag, Al, Fe, Ti, Zn, Co, and stainless-steel.

### (Positive Electrode Active Material Layer)

The positive electrode active material layer used in the solid-state battery of the present disclosure includes a positive electrode active material, and may further optionally include an electrolyte, a conductive aid, a binder, and the like. In addition, the positive electrode active material layer may contain various additives. The content of each of the positive electrode active material, the electrolyte, the conductive aid, the binder, and the like in the positive electrode active material layer may be appropriately determined in accordance with the desired battery performance.

The electrolyte that may be included in the positive electrode active material layer may be a solid electrolyte, a liquid electrolyte, or a combination thereof.

In the positive electrode active material layer, the ratio of the mass of the positive electrode active material particles to the total mass of the positive electrode active material particles and the inorganic solid electrolyte particles may be 30% by mass or more, 40% by mass or more, 50% by mass or more, 60% by mass or more, 70% by mass or more, or 80% by mass or more, and may be 95% by mass or less, 90% by mass or less, 85% by mass or less, or 80% by mass or less.

The thickness of the positive electrode active material layer may be 1 μm or more, 10 μm or more, 30 μm or more, or 50 μm or more, and may be 100 μm or less, 80 μm or less, 60 μm or less, or 40 μm or less.

### Electrolyte Layer

The electrolyte layer used in the solid-state battery of the present disclosure includes at least an electrolyte. The electrolyte layer may contain a solid electrolyte, and may optionally contain a binder or the like. In this case, the content of the solid electrolyte, the binder, and the like in the electrolyte layer is not particularly limited. In addition, the electrolyte layer may contain various additives. The electrolyte layer may include a liquid component together with the solid electrolyte. Alternatively, the electrolyte layer may include an electrolyte solution, and may further include a separator or the like for holding the electrolyte solution and preventing contact between the positive electrode and the negative electrode.

### (Negative Electrode Current Collector Layer)

The negative electrode layer used in the solid-state battery of the present disclosure may include a negative electrode current collector layer in contact with the negative electrode active material layer. Any of the negative electrode current collector layers generally used as the negative electrode current collector layer of a battery can be adopted. The negative current collector layer may be foil-like, sheet-like, mesh-like, punching metal-like, porous-like, and foam-like. The negative electrode current collector layer may be a metal foil or a metal mesh, or may be a carbon sheet. In particular, the metal foil is useful in view of handling properties and the like. The negative electrode current collector layer may be formed of a plurality of foils or sheets. Examples of the negative electrode current collector include Cu, Ni, Cr, Au, Pt, Ag, Al, Fe, Ti, Zn, Co, and stainless-steel. In particular, from the viewpoint of ensuring reduced resistance and from the viewpoint of difficulty in alloying with lithium, the negative electrode current collector layers may contain at least one metal selected from Cu, Ni and stainless steel.

### EXAMPLES

### Example 1

### Preparation of Positive Electrode Layer

To a polypropylene container, butyl butyrate as a dispersing medium, a 5% by weight butyl butyrate solution of a polyvinylidene fluoride-based binder, a LiNi1/3Co1/3Mn1/3O2 having a mean particle diameter of 6 μm as positive electrode active material particles, a Li2S—P2S5 glass-ceramic as sulfide solid-electrolyte particles, and a vapor-phase carbon-fiber as a conductive aid were added to obtain a positive electrode mixture slurry.

Here, in the positive electrode active material layer, the mass ratio of the positive electrode active material particles to the solid electrolyte particles was 85:15. The thickness of the positive electrode active material layer was 35 μm.

The positive electrode mixture slurry was stirred for 30 seconds with an ultrasonic dispersing device (UH-50 manufactured by S.M.), shaken with a shaker (manufactured by Shibata Science Co., Ltd., TTM-1) for 3 minutes, and stirred with an ultrasonic dispersing device for 30 seconds. Thereafter, the positive electrode mixture slurry was coated on an aluminum foil (manufactured by Showa Denko Co., Ltd.) as a positive electrode current collector layer by a blade method using an applicator, and dried on a hot plate at 100° C. for 30 minutes to obtain a positive electrode layer having a positive electrode active material layer and a positive electrode current collector layer.

### Preparation of Negative Electrode Layer

To a polypropylene-made container, butyl butyrate as a dispersing medium, 5 wt % butyl butyrate solutions of PVDF based binders, conductive aid (gas phase method carbon fibers), porous silicon and graphite particles as negative electrode active materials, and sulfide solid electrolyte particles (Li2S—P2S5 based glass ceramics) were added to obtain a negative electrode mixture slurry.

Here, in the negative electrode active material layer, the mass ratio of the negative electrode active material particles to the solid electrolyte particles was 55:45. The ratio of the mass of the graphite particles to the total mass of the porous silicon particles and the graphite particles was 10 mass %. The thickness of the negative electrode active material layer was 21 μm. The porous silicon particles had a median diameter (D50) of about 1.0 microns. The graphite grains had a median diameter (D50) of about 10 microns and an aspect-ratio of about 3.

The negative electrode mixture slurry was stirred for 30 seconds with an ultrasonic dispersing device (UH-50 manufactured by S.M.), and shaken with a shaker (TTM-1, manufactured by Shibata Science Co., Ltd.) for 30 minutes. Thereafter, using an applicator, the negative electrode mixture slurry was coated on a copper foil (made of UACJ) as a negative electrode current collector layer by a blade method, and dried on a hot plate at 100° C. for 30 minutes to obtain a negative electrode layer having a negative electrode active material layer and a negative electrode current collector layer.

Preparation of Solid Electrolyte Layer with Release Sheet To a polypropylene-made container, heptane, a 5 wt % heptane solution of a butyl-rubber-based binder, and a sulfide solid electrolyte (Li2S—P2S5 glass-ceramic) were added to obtain a solid electrolyte mixture slurry.

The solid-electrolyte mixture slurry was stirred for 30 seconds with an ultrasonic dispersing device (UH-50 manufactured by S.M.), and the vessel was shaken with a shaker (TTM-1, manufactured by Shibata Science Co., Ltd.) for 30 minutes. Thereafter, the solid electrolyte mixture slurry was coated on an aluminum foil as a release layer by a blade method using an applicator, and dried on a hot plate at 100° C. for 30 minutes to obtain a solid electrolyte layer with a release sheet.

### Battery Preparation

The solid electrolyte layer with a release sheet and the positive electrode layer obtained as described above were laminated in the order of a release sheet, a solid electrolyte layer, a positive electrode active material layer, and a positive electrode current collector layer. The laminate was roll-pressed at a 100 kN/cm press pressure and a press temperature of 165° C., and then the release sheet was peeled off to obtain a positive electrode laminate.

The solid electrolyte layer with a release sheet and the negative electrode layer obtained as described above were laminated in the order of a release sheet, a solid electrolyte layer, a negative electrode active material layer, and a negative electrode current collector layer. The laminate was roll-pressed at a 60 kN/cm press pressure and a press temperature of 25° C., and the release sheeting was peeled off to obtain a negative electrode laminate.

The solid electrolyte layer with peel sheet and the negative electrode laminate obtained as described above were laminated in the order of a release sheet, a solid electrolyte layer (intermediate solid electrolyte layer), a solid electrolyte layer, a negative electrode active material layer, and a negative electrode current collector layer. The laminate was subjected to a planar uniaxial press for 10 seconds at a 100 MPa press pressure and a press temperature of 25° C., and the release sheet was peeled off to obtain a negative electrode laminate with an intermediate solid-state electrolyte layer.

The negative electrode laminate with the intermediate solid electrolyte layer and the positive electrode laminate were prepared so that the area of the negative electrode laminate with the intermediate solid electrolyte layer was larger than the area of the positive electrode laminate.

The positive electrode laminate and the negative electrode laminate with an intermediate solid electrolyte layer obtained as described above were laminated in the order of a positive electrode current collector layer, a positive electrode active material layer, a solid electrolyte layer, an intermediate solid electrolyte layer, a solid electrolyte layer, a negative electrode active material layer, and a negative electrode current collector layer. The laminate was subjected to planar uniaxial pressing at a 200 MPa pressing pressure and a pressing temperature of 120° C. for 1 minute to obtain a solid- state cell of Example 1.

### Evaluation of Porosity

As the porosity, the ratio of the void volume in the negative electrode active material layer to the total volume of the negative electrode active material layer was examined. The porosity of the negative electrode active material layer was determined by the following formula:

Porosity (%)=(1−x/y)×100
x: Total volume of each material obtained by dividing the weight of each material constituting the negative electrode active material layer by the true density of each material
y: Apparent volume obtained from the dimensions of the actual negative electrode active material layer

### Evaluation of Capacity Retention Rate

The solid-state batteries obtained as described above were restrained at a predetermined restraining pressure (5 MPa) using a restraining tool, discharged to a 3.0V at a 1.0 C, charged at a constant current-constant voltage to a 4.35V at a 0.33 C, and discharged at a constant current-constant voltage to a 3.00V at a 0.33 C to define an initial capacity. Thereafter, the charge-discharge test in 2.0 C was repeated 200 times, and the retention rate from the initial capacity was calculated.

### Examples 2 to 3 and Comparative Examples 1 to 3

In the preparation of the negative electrode layer, the solid-state batteries of Examples 2 to 3 and Comparative Examples 1 to 3 were prepared and evaluated as in Example 1, except that the mass ratio of porous silicon and graphite as the negative electrode active material was changed as shown in Table 1.

### Evaluation Results

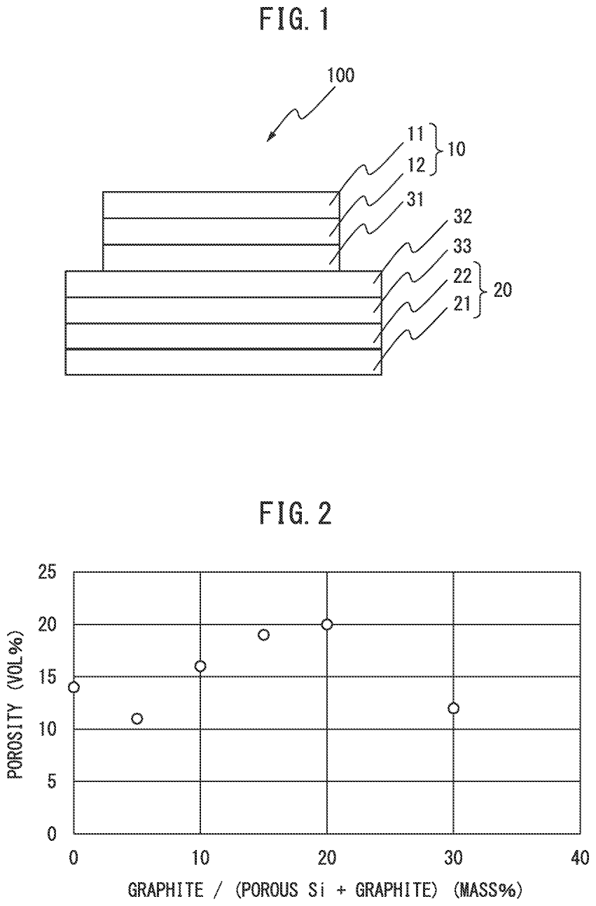

For Examples 1 to 3 and Comparative Examples 1 to 3, the ratio of the mass of the graphite particles to the total mass of the porous silicon particles and the graphite particles as the negative electrode active material, the porosity of the negative electrode active material layer, and the capacity retention ratio of the solid-state battery are shown in Table 1 and FIGS. 1 and 2.

### [Table 1]

TABLE 1

| | Ratio of mass of graphite | Porosity of | Capacity |
|---|---|---|---|
| | particles to total mass of | negative | retention |
| | porous silicon | electrode active | ratio of |
| | particles and graphite | material layer | solid-state |
| | particles (mass %) | (Vol. %) | batteries (%) |
| Comp. Ex. 1 | 0 | 14 | 73.0 |
| Comp. Ex. 2 | 5 | 11 | 71.6 |
| Ex. 1 | 10 | 16 | 85.4 |
| Ex. 2 | 15 | 19 | 97.7 |
| Ex. 3 | 20 | 20 | 96.5 |
| Comp. Ex. 3 | 30 | 12 | 67.3 |

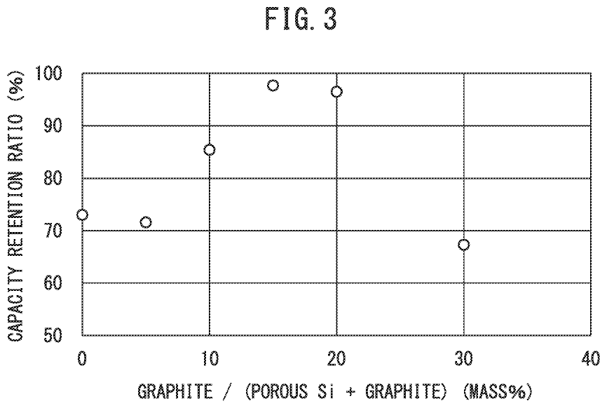

As shown in Table 1 and FIGS. 2 and 3, in Examples 1 to 3 in which the ratio of the mass of the graphite particles to the total mass of the porous silicon particles and the graphite particles was 10% by mass, 15% by mass, and 20% by mass, respectively, the porosity of the negative electrode active material layer was relatively large, and the capacity retention ratio of the solid-state battery was also relatively large. This is considered to be because the negative electrode active material layer contains an appropriate amount of graphite particles, so that the graphite particles function as pillars, thereby suppressing the pores in the porous silicon particles from collapsing. Note that the pores in the porous silicon particles are useful for absorbing expansion and contraction caused by charging and discharging of the battery, thereby improving the capacity retention ratio of the battery.

On the other hand, in Comparative Example 1 in which the graphite particles were not used, since the pillars (columns) as described above were not present, it is considered that the voids of the porous silicon particles collapsed, whereby the porosity of the negative electrode active material layer became relatively small, and the capacity retention ratio of the solid-state battery was also relatively small.

In Comparative Example 2 in which the ratio of the mass of the graphite particles to the total mass of the porous silicon particles and the graphite particles was 5% by mass, the porosity of the negative electrode active material layer was relatively small, and the capacity retention ratio of the solid-state battery was also relatively small compared with Comparative Example 1 in which the graphite particles were not used. This is believed to be due to the fact that a small amount of graphite particles, in turn, promoted collapse of the porous silicon particles.

In Comparative Example 3 in which the ratio of the mass of the graphite particles to the total mass of the porous silicon particles and the graphite particles was 30% by mass, the porosity of the negative electrode active material layer was relatively small and the capacity retention ratio of the solid-state battery was also relatively small compared with Comparative Example 1 in which the graphite particles were not used. This is believed to be due to the relatively low amount of porous silicon particles and therefore the reduced amount of voids provided by the mechanism of the porous silicon particles.

Referring to FIG. 1, a solid-state battery is generally illustrated at 100. The solid-state battery 100 includes a positive electrode 10, a solid electrolyte layer 31, a solid electrolyte layer 32, a solid electrolyte layer 33, and a negative electrode 20. The positive electrode 10 includes a positive electrode current collector layer 11 and a positive electrode active material layer 12. The negative electrode 20 includes a negative electrode current collector layer 21 and a negative electrode active material layer 22.

### EXPLANATION OF REFERENCE NUMERALS

10 Positive electrode
11 Positive electrode current collector layer
12 Positive electrode active material layer
31, 32, 33 Solid electrolyte layer
20 Negative electrode
21 Negative electrode current collector layer
22 Negative electrode active material layer
100 Solid-state battery

1. A negative electrode active material layer,
wherein the negative electrode active material layer contains porous silicon particles, graphite particles, and inorganic solid electrolyte particles, and
wherein the ratio of the mass of the graphite particles to the total mass of the porous silicon particles and the graphite particles is 10% by mass to 25% by mass.

2. The negative electrode active material layer according to claim 1, wherein the porous silicon particles are porous clathrate silicon particles.

3. The negative electrode active material layer according to claim 1,
wherein the inorganic solid electrolyte particles are sulfide solid electrolyte particles,
wherein the ratio of the total mass of said porous silicon particles and said graphite particles to the total mass of said porous silicon particles, said graphite particles, and said inorganic solid electrolyte particles is 30 mass % to 85 mass %, and
wherein the average aspect ratio of the graphite particles is 1.5 or more, and
wherein D50 diameter of the graphite particles is 2 times to 20 times D50 diameter of the porous silicon particles,

4. A solid-state battery, comprising the negative electrode active material layer according to claim 1, the solid electrolyte layer, and the positive electrode active material layer in this order.

5. The method for producing a negative electrode active material layer according to claim 1, comprising roll pressing.
